(19) United States
(12) Patent Application Publication
(10) Pub. No.: US 2001/0026851 A1
(43) Pub. Date: Oct. 4, 2001

(54) Method of manufacturing a plastics material part including a decorative film, and a part obtained thereby

(76) Inventor: Olivier Hilmarcher, Dortan (FR)

Correspondence Address: OLIFF & BERRIDGE, PLC, 277 S. WASHINGTON STREET, SUITE 500, ALEXANDRIA, VA, 22314, US

(21) Appl. No.: 09/774,648

(22) Filed: Apr. 24, 2001

(30) Foreign Application Priority Data
Feb. 2, 2000 (FR) 00 01304

(51) Int. Cl. B32B 3/00; B29C 45/14; B29C 47/06; B32B 31/00

(52) U.S. Cl. 428/31; 264/132; 264/259; 264/513; 156/244.11; 156/244.16; 264/173.16

(57) ABSTRACT

A method of manufacturing a plastics material part, the method being characterized by the fact that it comprises the following steps:

making a multilayer structure (2) having at least one protection layer (2a) satisfying the constraints for use in the automotive field and a support layer (2b) for providing the mechanical strength of the multilayer structure (2) after it has been shaped, the structure being made by assembling the protection layer and the support layer directly or with one or more intermediate decoration layers (2c) interposed between them, said assembly being performed by a method in which at least one of the layers to be assembled is in an at least partially-melted state so as to enable assembly to be performed by local melting of material;

shaping the multilayer structure, preferably by thermoforming, so as to give it a shape that is not plane;

optionally trimming it;

placing it in a mold;

overmolding thermoplastic material (9) on one of the faces of the multilayer structure either locally or over its entire surface; and

extracting the assembly from the mold.

The present invention relates to manufacturing plastics material parts by the “insert molding” method, which consists in shaping a thin multilayer structure, optionally in trimming it to give it the outline of the part to be made, and in placing it in a mold, after which a mass of thermoplastic material is overmolded onto said multilayer structure either locally or over its entire surface so as to produce a decorated plastics material part.

In the automotive industry, the outside face of a multilayer structure must have a layer of material that is particularly strong so as to provide protection against the outside surroundings.

Proposals have thus been made to form the outermost layer out of polyvinylidene fluoride (PVDF) and of polymethylmethacrylate (PMMA).

PVDF has the advantages of being capable of being subjected to a large amount of elongation during a thermoforming operation and of satisfying durability constraints in the automotive industry.

PMMA makes it possible to minimize the loss of shine during the thermoforming operation and to increase transparency and the degree of distinctiveness of image (DOI) of the outer layer.

The multilayer structure also has a support layer for giving it a degree of mechanical strength and enabling it substantially to conserve its shape after the thermoforming operation and until it is put into place in the mold.

This support layer can also provide color.

It is relatively thick, and in known multilayer structures its thickness lies in the range 400 micrometers (μm) to 800 μm.

Between the support layer and the protection layer, the multilayer structure can include a decorative layer that is colored in its bulk.

Thus, multilayer structures are known in which the protective layer is constituted by a transparent alloy of PVDF and of PMMA, the support layer is constituted by acrylonitrile butadiene styrene (ABS) or polypropylene (PP), and the decoration layer is constituted by a bulk-colored alloy of PVDF and of PMMA.

The protection layer is optionally printed using conventional inks that are not reactivatable when hot.

To ensure cohesion between the support layer and the decoration layer, conventional multilayer structures make use of a thin layer of polyurethane (PU) binder, since it would otherwise be difficult to secure the decoration layer onto the support layer, given the presence of PVDF which is poorly compatible with the polymer used for making the support layer.

U.S. Pat. No. 5,916,643 discloses a method in which the protection layer is made on a removable support film by a coating method of the reverse roll coating type. The protection layer is assembled to the underlying layer by being passed between cylinders that are raised to a high temperature, at about 200° C. to 220° C., so as to activate an adhesive that enables the two layers to be assembled together.

International patent application WO 94/03337 discloses a method whereby the film is shaped in the mold cavity in which the thermoplastic material is overmolded. That is therefore not an insert molding method.

The present invention seeks to simplify the manufacture of parts by means of an insert molding method.

The invention achieves this by means of a novel method of manufacture which is characterized by the fact that it comprises the following steps:

making a multilayer structure having at least one protection layer satisfying the constraints for use in the automotive field and a support layer for providing the mechanical strength of the multilayer structure after it has been shaped, the structure being made by assembling the protection layer and the support layer directly or with one or more intermediate decoration layers interposed between them, said assembly being performed by a method in which at least one of the layers to be assembled is in an at least partially-melted state so as to enable assembly to be performed by local melting of material;

shaping the multilayer structure, preferably by thermoforming, so as to give it a shape that is not plane;

optionally trimming it;

placing it in a mold;

overmolding thermoplastic material on one of the faces of the multilayer structure either locally or over its entire surface; and

extracting the assembly from the mold.

The method of the invention makes it possible to avoid using a binder when assembling together at least two layers, said assembly being performed by locally melting material.

This simplifies manufacture of the multilayer film.

The multilayer structure is shaped outside the mold in which the thermoplastic material is overmolded, as in the insert molding method.

Preferably, the layer (e.g. the support layer) which is in an at least partially molten state in order to be brought into contact with the layer with which it is to be assembled, is a layer exiting an extruder.

Preferably, the protection layer and the support layer are assembled together by hot rolling or by calendering and surface coating.

Advantageously, prior to being assembled, at least one of the protection layer and the support layer is tensioned, preferably by means of a generally banana-shaped rotary element.

This prevents kinks or folds forming during assembly.

Advantageously, the multilayer structure has at least three layers, namely: a protection layer; at least one decoration layer; and a support layer.

In an implementation, the multilayer structure has three layers, namely a protection layer, a decoration layer, and a support layer.

To make the protection layer, it is possible to use transparent plastics materials such as PMMA, polycarbonate (PC), PVDF, and other fluorine-containing polymers, polyamides (PA), ABS, polystyrene (PS), metallocene polypropylenes (PP), polyethylene terephthalate (PET), polymers of the acrylic family, alloys comprising one or more polymers selected from the above list, copolymers comprising one or more polymers selected from the above list, or assemblies of polymers selected from the above list, e.g. a layer of PVDF and a layer of PC or a layer of PVDF and a layer of PMMA. It is particularly advantageous to use PA.

The protection layer can be in the form of a single layer film, being preferably obtained by extruding a plastics material.

The protection layer is preferably made on the basis of an alloy of two polymers, preferably an alloy of PVDF and of PMMA.

In a variant, the protection layer can be in the form of a two-layer film, preferably obtained by coextruding two plastics materials. The outer layer of the two-layer film is advantageously made of a material such as a fluorine-containing polymer, preferably PVDF.

The inner layer of the two layer film is advantageously a material that is easier to decorate or to assemble, and that is compatible with the material used to make the underlying layer of the multilayer structure so as to make it possible to assemble the layers without using a binder, using a method such as coating with acrylic resin, hot rolling, lining, surface coating, or calendering.

The inner layer is preferably based on PMMA.

When the protection layer includes PMMA, its thickness is preferably less than 150 μm so as to avoid causing it to be brittle.

By way of example, the support layer can have a single layer structure or a two-layer structure and the support layer can be made out of plastics materials such as ABS, polyolefins (PP, PE, . . . ), PET, PC, and alloys comprising one or more polymers selected from the above list.

The support layer is preferably based on PP or ABS.

When the support layer has a two-layer structure, the top layer is advantageously tinted, with a thickness of a few μm, thereby enabling the bottom layer to be non-tinted, which is less expensive.

The top layer can also be made of a material that facilitates adhesion of the underlying layer to the protection layer or decoration layer, said material optionally being colored.

The top layer can be based on bulk-tinted modified PP and the bottom layer can be based on PP.

By way of example, the decoration layer is constituted by at least one layer of hot-reactivatable ink, preferably of an acrylic nature, deposited on the inside face of the protection layer or on the support layer, the ink preferably being deposited by a photogravure printing method.

It is also possible to use other methods such as flexography, silk-screen printing, or offset printing.

The support layer or the protection layer can receive different inks, e.g. to print a pattern.

Printing can be performed by successive passes with different inks, the last pass possibly applying to the entire surface of the support layer or the protection layer in order to give it a background color.

By way of example, possible keying problems with the ink can be avoided by using a two-layer film for making the protection layer, with the outer layer being constituted by a fluorine-containing polymer and the inner layer by a polymer that is compatible with the ink.

The above-mentioned hot-reactivatable inks advantageously comprise a hot-melt component.

The invention also provides a multilayer structure used to implement the above-defined method.

The invention also provides a plastics material part made by means of the above method, and in particular a motor vehicle bodywork part.

The invention will be better understood on reading the following detailed description of non-limiting implementations, and on examining the accompanying drawings, in which:

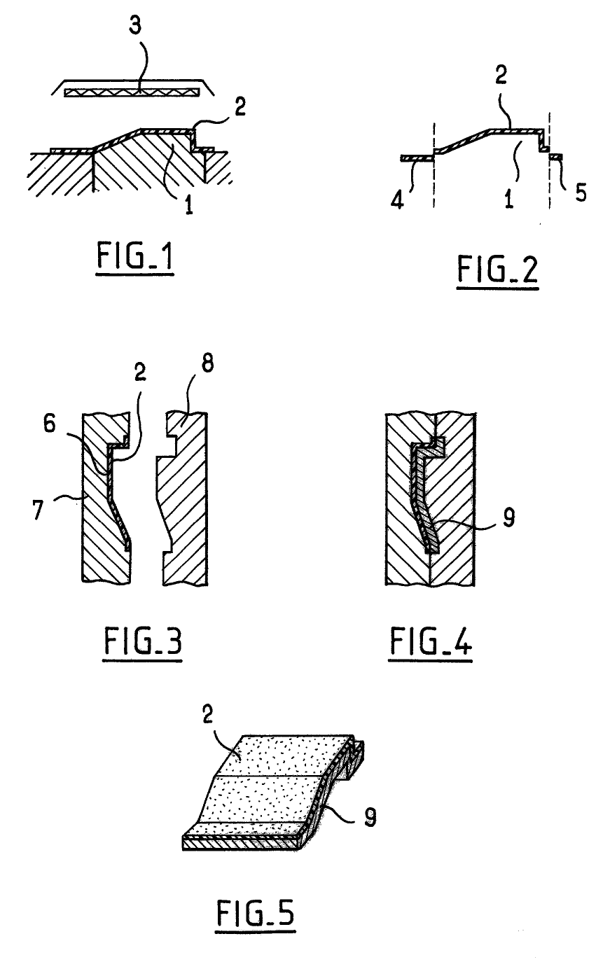

FIGS. 1 to 5 illustrate the insert molding method;

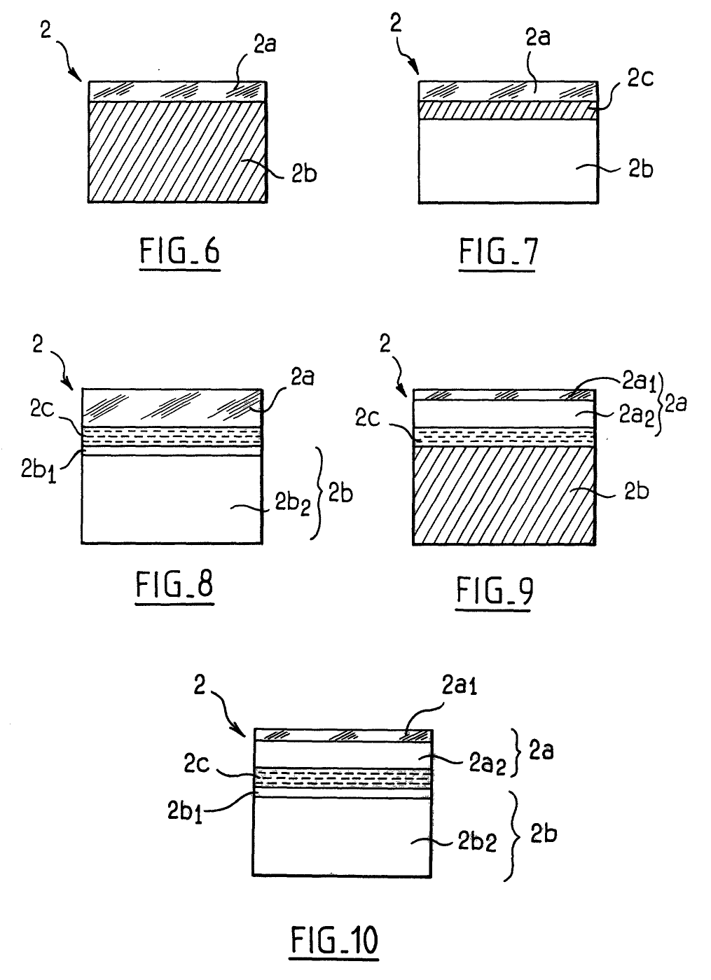

FIGS. 6 to 10 are diagrammatic sections showing various configurations of the multilayer structure of the invention;

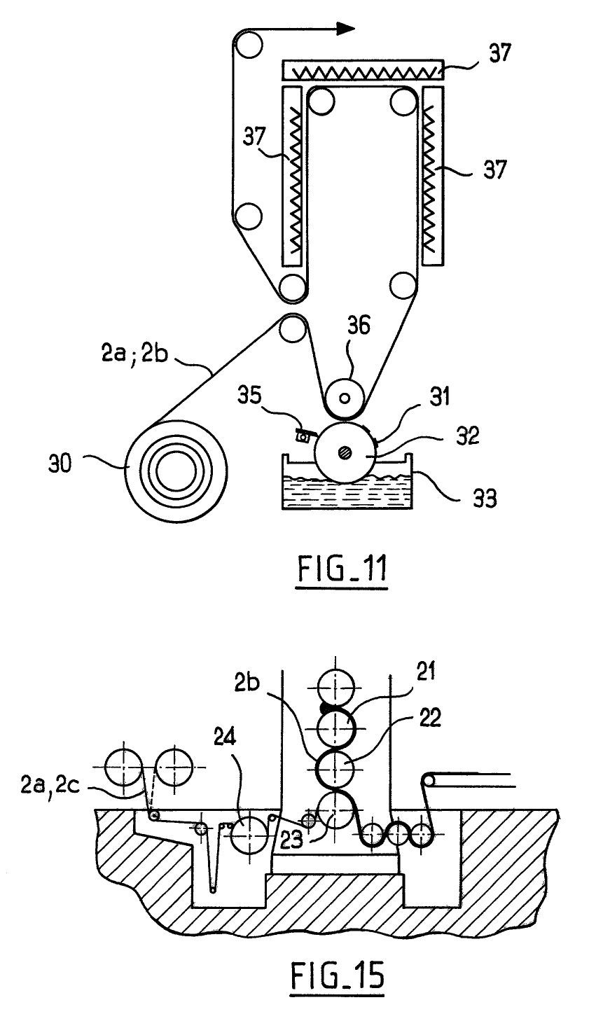

FIG. 11 is a diagram showing the photogravure method;

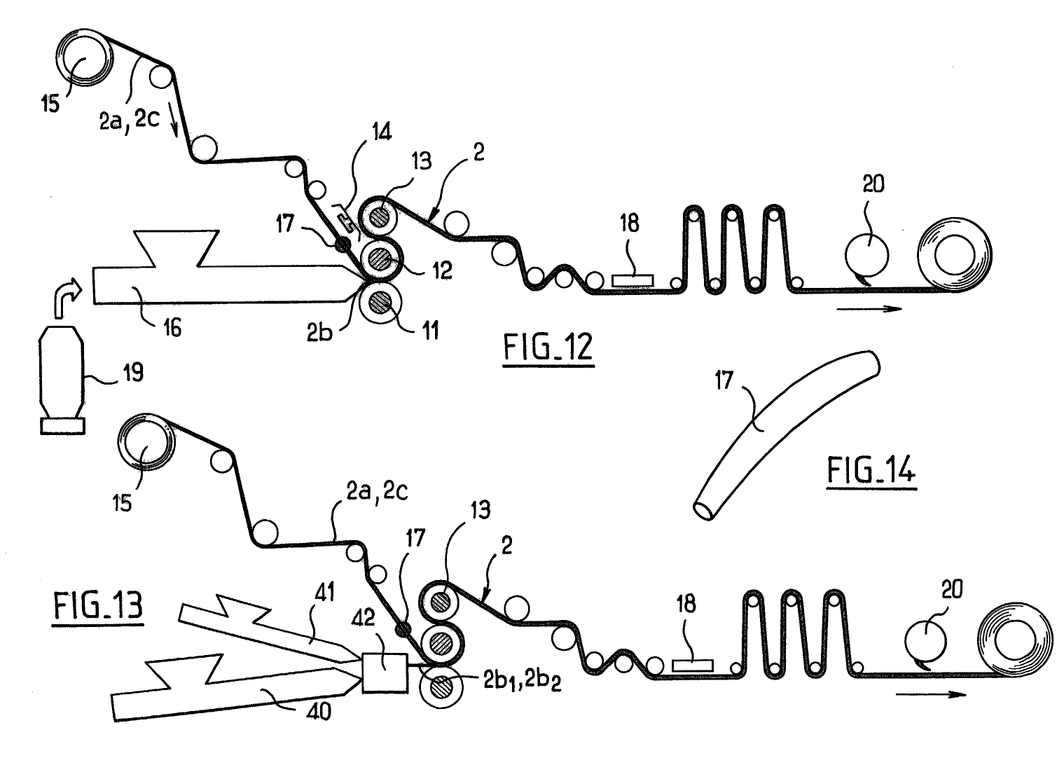

FIGS. 12 and 13 are diagrams showing two variants of the acrylic resin coating method;

FIG. 14 is a diagrammatic perspective view showing, in isolation, a rotary element used for tensioning the film; and

FIG. 15 is a diagram showing the calendering and surface coating method.

In the example shown, the insert molding method consists in providing a multilayer structure of characteristics specified below, which is initially in the form of a film 2, in placing the film 2 on a thermoforming die 1 whose relief is selected as a function of the part to be made, and in heating the film 2 with heater means 3 so as to shape it, as illustrated in FIG. 1.

After thermoforming, the film 2, now referred to as a “preform”, can be cut to size as shown in FIG. 2 so as to remove unwanted portions 4 and 5 and cause the outline of the preform 2 to coincide with the outline of the part to be made.

The film 2 is then placed in a mold having two portions 7 and 8.

The film 2 is placed in the bottom of the recess 6 in the first portion 7 of the mold, as shown in FIG. 3.

The second portion 8 is suitable for co-operating with the first portion, when pressed thereagainst, to constitute a mold cavity as shown in FIG. 4.

Molten thermoplastic material is injected into the mold cavity that is formed in this way in contact with the face of the film 2 that faces away from the recess 6.

The part that is extracted from the mold, as shown in FIG. 5, is not plane in shape, and one of its faces is defined by the film 2.

Once it has cooled, the thermoplastic material 9 provides the mechanical strength for the part while the film 2 constitutes protection and decoration and avoids any need to paint the part.

This method can be used to make all types of motor vehicle bodywork parts, for example a radiator grille, a bumper strip, a fender, etc.

Various non-limiting examples for the structure of the film 2 are described below with reference to FIGS. 6 to 9.

In general, the film 2 has at least one protection layer and at least one support layer.

The protection layer is intended to ensure that after thermoplastic material has been overmolded onto the part it is compatible with use in the automotive industry.

This protection layer presents:

good adhesion with the underlying layer (as measured by the “checker-board test”);

good resistance to the action of cleaning brushes and good resistance to high pressure cleaning;

good resistance to being hit by chippings, in particular when the vehicle is traveling at high speed, e.g. in the range 200 kilometers per hour (km/h) to 250 km/h;

good protection against fluids, in particular fuels (gasoline, diesel oil), cleaning liquids for cleaning windshields, and substances used for packaging and unpackaging, e.g. waxes used to protect parts prior to assembly;

good resistance to aging, to light, to bad weather, to heat, and to moisture;

good resistance to scratching;

good resistance to climatic cycles, in particular temperature variations; and

good elongation behavior during thermoforming.

By way of example, the thickness of the protection layer is several tens of μm.

The support layer is to enable the preform to retain its shape after the thermoforming operation and to enable it to be transferred to the mold in which the thermoplastic material is overmolded thereon, and also to enable it to withstand the flow of plastics material inside the mold during overmolding.

By way of example the thickness of the support layer is several hundreds of μm.

In FIG. 6, the film 2 comprises a transparent protection layer 2a and a bulk-tinted support layer 2b.

In the example of FIG. 7, the film 2 comprises a protection layer 2a, a support layer 2b whose color can be arbitrary, and a decoration layer 2c sandwiched between the protection layer 2a and the support layer 2b.

The support layer 2b is optionally colored and the decoration layer 2c is optionally partially transparent.

By way of example, the decoration layer 2c can be constituted by lines printed on the protection layer 2a or on the support layer 2b so as to give the part the appearance of brushed aluminum.

In the example described the decoration layer 2c is printed on the protection layer or on the support layer by a photogravure method, as shown in FIG. 11.

The protection layer 2a or the support layer 2b is unreeled from a reel 30 and has its face for printing brought into contact with an etched surface 31 on a rotating cylinder 32.

The etched surface 31 picks up ink by being partially immersed in a vessel 33 containing the ink, as the cylinder 32 rotates.

A scraper 35 placed close to the cylinder 32 serves to wipe the ink over the etched surface 31 in such a manner as to control the quantity of ink that covers the protection layer 2a or the support layer 2b that is subjected to printing by passing between the cylinder 32 and a presser cylinder 36.

After printing, the protection layer 2a or the support layer 2b is passed through a dryer having a plurality of air blowers 37.

In the example described, the background color is provided by the support layer 2b which is tinted gray, for example.

In a variant, the background color can be provided by performing a pass through ink that covers the entire surface of the support 2b.

The decoration layer 2c can correspond to printing one or more hot-reactivatable inks.

When a plurality of inks are used, the inks need not be superposed and can merely be juxtaposed, so as to constitute a single layer.

A plurality of photogravure stations can be used one after another.

In order to simplify the drawing, the decoration layer 2c is shown in all the figures as being constituted by a single layer.

The multilayer film can have configurations other than those shown in FIGS. 6 and 7.

In the example of FIG. 8, the film 2 comprises a protection layer 2a, a support layer 2b, and a decoration layer 2c.

The support layer 2b is itself of two-layer structure being made up of layers 2b₁, and 2b₂.

The top layer 2b₁ can be used to provide the background color and to facilitate adhesion between the layers 2c and 2b, while the bottom layer 2b₂ can be of any color.

The support layer 2b, regardless of whether it comprises one or two layers, is preferably based on PP or on ABS.

In a variant, it can be based on PE, PET, or PC.

As mentioned above, the decoration layer 2c can be made by one or more prints on the support layer and/or the protection layer using hot-reactivatable inks, and the ink layers can be superposed or they can comprise a single layer only.

The protection layer 2a in the example of FIG. 8 is of single-layer structure and it is made by extruding a PVDF and PMMA alloy.

In the example of FIG. 9, the film 2 has a protection layer 2a, a support layer 2b, and a decoration layer 2c, the support layer 2b optionally being colored in its bulk so as to constitute a colored background, and the decoration layer being constituted by one or more layers of ink deposited by printing on the protection layer 2a or on the support layer 2b.

In this case, the protection layer 2a has a two-layer structure 2a₁, 2a₂.

The top layer 2a₁ is to impart resistance against the external medium while the bottom layer 2a₂ facilitates keying or adhesion of the hot-reactivatable inks of the decoration layer 2c.

The protection layer 2a can be made by coextruding two plastics materials, the top layer 2a₁ of this two-layer film being advantageously constituted as in the example described by a fluorine-containing polymer, preferably PVDF, while the bottom layer 2a₂ is preferably constituted by PMMA.

By way of example, the thickness of the top layer 2a₁ is a few μm and the thickness of the bottom layer 2a₂ is a few tens of μm.

In the example of FIG. 10, the film 2 has a protection layer 2a presenting two-layer structure 2a₁, 2a₂ like the film 2 in FIG. 9, a decoration layer 2c, and a support layer 2b that likewise presents two-layer structure 2b₁, 2b₂ like the film 2 in FIG. 8.

In general, when the protection layer or the support layer is made (at least on its face to be decorated) out of a material whose chemical nature makes it difficult for ink to key thereto, the protection layer or the support layer is subjected to surface treatment prior to the printing operation for the purpose of improving ink keying, e.g. a chemical treatment such as chromic oxidation treatment or oxidation by organometallic compounds, or flame treatment, or electromagnetic treatment, or UV irradiation treatment, or electron or ion bombardment, or corona or plasma treatment, with this list not being limiting.

In particular, such surface treatments are particularly recommended when the protection layer or the support layer includes polymers from the polyolefin family.

To assemble the protection layer and the support layer together, it is preferable to perform an acrylic resin coating method, which is synonymous in this case with hot rolling.

The hot rolling method is shown in FIGS. 12 and 13.

FIG. 12 relates to making the film of FIG. 7 comprising a single layer protection layer with a decorated face and assembled with the support layer which likewise comprises a single layer.

The decorated protection layer 2a, 2c is unreeled from a storage reel 15 and is brought so that its decorated face which carries hot-reactivatable inks comes into contact with the support layer 2b coming out of an extruder 16, contact taking place between cylinders 11 and 12 that are rotated.

Before passing between the cylinders 11 and 12, the decorated protection layer 2a, 2c is tensioned by means of a rotary element 17 that is generally banana-shaped and shown in isolation in FIG. 14.

The decorated protection layer 2a, 2c passes in alternation in the recess and then over the bulge of the rotary element 17, thereby enabling it to be tensioned.

This ensures that accidental folds do not form in the layer 2a, 2c while it is passing between the cylinders 11 and 12.

A dryer 19 serves to dry the material prior to delivering it to the extruder.

The ink(s) of the decorated protection layer 2a, 2c, is/are heated in the example described by means of infrared radiation from a heater strip 14, and the support layer 2b is still hot such that when the decorated protection layer 2a, 2c and the support layer 2b come into contact they become assembled together by local melting of material.

In a variant, the heater strip 14 can be omitted.

The cylinders 11 and 12 in the example described are raised to a relatively low temperature, less than 100° C., preferably lying in the range about 60° C. to 90° C., there being no need to heat the layers that are to be assembled together since the material leaving the extruder 16 is hot, at a temperature in excess of 160° C. in the example described.

The temperature of the cylinders 11, 12, and 13 can be 60° C., 90° C., and 35° C. respectively, for example.

The assembled film passes between the cylinder 12 and an outlet cylinder 13 and is then directed towards a device 18 for monitoring its thickness.

Thereafter the film 2 passes through a cutter device 20 which trims the edges of the strip so as to obtain the desired width.

The off-cuts can be ground up and then reincorporated in the manufacturing line, or they can be stored.

The method described above also applies when replacing the decorated protection layer wound on the storage reel 15 by the optionally decorated support layer, with the protection layer then being extruded by means of the extruder 16.

This method also applies when the extruded layer has a multilayer structure, as shown by way of example in FIG. 13.

In this figure, the support layer 2b₁, 2b₂ is made by coextruding two plastics materials by means of extruders 40 and 41 feeding into a rheological adapter 42 known as a “feed block”.

The extruded two-layer structure 2b₁, 2b₂ is assembled with a protection layer 2a as in the example of FIG. 12.

This method also applies when the protection layer 2a is replaced by the support layer 2b and a protection layer is extruded having two-layer structure 2a₁, 2a₂.

FIG. 15 shows the calendering and surface-coating method in which the decorated protection layer 2a, 2c is brought so that its decorated face comes into contact with a calendered support layer 2b coming from an extruder and passing between rollers 21 and 22, with contact and assembly of the decorated protection layer 2a, 2c with the support layer taking place between the rollers 22 and 23.

Prior to coming into contact with the support layer 2b, the decorated protection layer 2a, 2c is heated by means of a heater drum 24.

The heater drum 24 seeks to reactivate the decorated protection layer 2a, 2c by heating it prior to assembling it with the support layer 2b.

The protection layer 2a can have a multilayer structure.

In a variant, it is the support layer which is decorated instead of the protection layer, and it is the protection layer which is calendered between the rollers 21 and 22 and laid onto the decorated support layer.

In which case, the support layer can have a multilayer structure as shown in FIG. 8, for example.

### EXAMPLE 1

A film was prepared having the following structure:

protection layer 2a: 55 μm thick PVDF/PMMA alloy;

decoration layer 2c: 8 μm thick; and

support layer 2b: 500 μm thick ABS.

The PVDF/PMMA alloy film was initially extruded using 32% PVDF and 68% PMMA by weight, without calendering.

The resulting film was photogravure printed in an installation having three stations, a first station having a “brushed aluminum” cylinder for printing fine discontinuous whitish lines. The first printing did not cover the entire surface of the film.

The second station comprised a “1000 point, electromechanical 40 screen” cylinder for printing a metallic silver gray background layer.

The third station likewise comprised a “1000 point, electromechanical 40 screen” cylinder for printing another metallic silver gray background layer.

A fourth station could have been used to deposit an additional background layer, in particular to increase the overall covering power of the background layer.

The viscosity of the ink used was 18 centipoise (cp) and its drying temperature was 80° C.

The film was then hot-rolled using the method described with reference to FIG. 12.

ABS was extruded to constitute the support layer, having the reference TERLURAN 997 VE as sold by BASF.

The ABS used was gray so as to improve the covering power imparted to the printed background layer.

The temperature of the material in the extrusion head was 226° C.

After the multilayer film had been thermoformed, ABS of reference ABS MAGNUM 8434 sold by DOW was overmolded thereon and thereafter tests were performed on resistance to scratching when subjected to impact from chippings, resistance to light, resistance to lead-free gasolines, to diesel oil, to fluids, to “weather ometer” aging, to washing using a high pressure cleaner, to aging when heated, to aging when wet, and to aging in climatic cycles, using the test methods required by manufacturers.

The results observed were good.

### EXAMPLE 2

A multilayer film was made having the following structure:

protection layer 2a: 55 μm thick PVDF/PMMA alloy;

decoration layer 2c: 8 μm thick; and

support layer 2b₁, 2b₂: 1st layer 2b₁: 500 μm thick bulk tinted modified PP; 2nd layer 2b₂: 500 μm thick non-modified PP.

The bulk tinted modified PP layer served to facilitate adhesion with the decorative inks.

The modified PP used was malleic anhydride acid (MAH) modified PP of reference BYNEL 50 E 662 sold by DUPONT.

The 500 μm thick non-modified PP layer was filled with 20% talc and is sold under the reference CZN 0525NL by APPRYL.

The multilayer film was made by implementing the method described with reference to FIG. 13.

The modified PP and non-modified layers were coextruded simultaneously using a feed block.

Tests were performed on the multilayer film analogous to those mentioned in Example 1, and they were satisfactory.

Naturally, the invention is not limited to the embodiments described above.

In particular, it is possible to use other assembly methods for assembling the protection and support layers together, with one or both of these layers optionally being previously decorated by means of hot-reactivatable inks, in particular by an extrusion coating method.

The multilayer structure can include a plurality of intermediate decorative layers in order to produce a depth effect.

1. A method of manufacturing a plastics material part, the method being characterized by the fact that it comprises the following steps:
making a multilayer structure (2) having at least one protection layer (2a) satisfying the constraints for use in the automotive field and a support layer (2b) for providing the mechanical strength of the multilayer structure (2) after it has been shaped, the structure being made by assembling the protection layer and the support layer directly or with one or more intermediate decoration layers (2c) interposed between them, said assembly being performed by a method in which at least one of the layers to be assembled is in an at least partially-melted state so as to enable assembly to be performed by local melting of material;
shaping the multilayer structure, preferably by thermoforming, so as to give it a shape that is not plane;
optionally trimming it;
placing it in a mold;
overmolding thermoplastic material (9) on one of the faces of the multilayer structure either locally or over its entire surface; and
extracting the assembly from the mold.

2. A method according to claim 1, characterized by the fact that the layer which is in an at least partially melted state is exiting an extruder.

3. A method according to the preceding claim, characterized by the fact that the protection layer (2a) and the support layer (2b) are assembled together by hot rolling.

4. A method according to the preceding claim, characterized by the fact that prior to being assembled, at least one of the protection layer (2a) and the support layer (2b) is tensioned, preferably by means of a generally banana-shaped rotary element.

5. A method according to claim 1 or 2, characterized by the fact that the protection layer (2a) and the support layer (2b) are assembled together by calendering and surface coating.

6. A method according to any preceding claim, characterized by the fact that the multilayer structure has at least three layers, namely: a protection layer (2a); at least one decoration layer (2c); and a support layer (2b).

7. A method according to any preceding claim, characterized by the fact that the protection layer (2a) is in the form of a single layer film, preferably obtained by extruding a plastics material.

8. A method according to any one of claims 1 to 6, characterized by the fact that the protection layer (2a) is in the form of a two-layer film, preferably obtained by coextruding two plastics materials.

9. A method according to the preceding claim, characterized by the fact that the outer layer (2a₁) of the two-layer film (2a) is made out of a material such as a fluorine-containing polymer, preferably PVDF.

10. A method according to either one of the two immediately preceding claims, characterized by the fact that the inner layer (2a₂) of the two-layer film (2a) is made out of a material that is compatible with the material used for making the underlying layer of the multilayer structure, and preferably out of PMMA.

11. A method according to any preceding claim, characterized by the fact that the protection layer is made out of one or more plastics materials selected from the following list: PMMA; PC; PVDF and other fluorine-containing polymers; PA; ABS; PS; metallocene PP; PET; polymers of the acrylic family; alloys comprising one or more of the above-specified materials; and copolymers comprising one or more of the above-specified materials.

12. A method according to the preceding claim, characterized by the fact that the protection layer (2a) is made of an alloy of two polymers, preferably PVDF and PMMA.

13. A method according to any one of claims 1 to 11, characterized by the fact that PA is used for making the protection layer (2a).

14. A method according to any preceding claim, characterized by the fact that the support layer (2b) has a single layer or a two-layer structure.

15. A method according to any preceding claim, in which the support layer (2b) has a two-layer structure, the method characterized by the fact that the top layer (2b₁) of the support layer (2b) is made of a material that facilitates adhesion with the protection layer or the decoration layer.

16. A method according to any preceding claim, the support layer (2b) having a two-layer structure, the method being characterized by the fact that the top layer (2b₁) of the support layer (2b) is made of a material presenting a color.

17. A method according to the two preceding claims, characterized by the fact that the top layer (2b₁) is made of a colored material selected to increase the adhesion of the underlying layer of the multilayer structure to the protection layer or the decoration layer.

18. A method according to any preceding claim, characterized by the fact that the support layer (2b) is made out of one or more plastics materials selected from the following list: ABS; polyolefins, in particular PP or PE; PET; or PC.

19. A method according to the preceding claim, characterized by the fact that PP is used for making the support layer (2b).

20. A method according to the preceding claim, characterized by the fact that the support layer (2b) has a two-layer structure, the top layer (2b₁) is made on the basis of bulk-tinted modified PP and the bottom layer (2b₂) based on non-modified PP.

21. A method according to claim 18, characterized by the fact that ABS is used to make the support layer (2b).

22. A method according to any preceding claim, characterized by the fact that the protection layer (2a) is decorated.

23. A method according to any preceding claim, characterized by the fact that the support layer (2b) is decorated.

24. A method according to any preceding claim, characterized by the fact that the multilayer structure includes a decoration layer (2c) constituted by one or more hot-reactivatable inks, preferably of an acrylic nature, deposited on the protection layer (2a) or on the support layer (2b), preferably by a printing method.

25. A method according to the preceding claim, characterized by the fact that the decoration layer (2c) is printed by a photogravure method.

26. A method according to any preceding claim, characterized by the fact that the support layer (2b) or the protection layer (2a) is printed by successive passes using different inks in order to make up a pattern.

27. A method according to the preceding claim, characterized by the fact that for a support layer (2b) made of PP, the last ink pass applies to the entire surface of the support layer (2b).

28. A method according to any one of claims 24 to 27, characterized by the fact that the protection layer or the support layer receives surface treatment prior to printing in order to facilitate keying of the ink.

29. A multilayer structure (2) used for implementing the method as defined in any preceding claim.

30. A plastics material part made by means of a method as defined in any one of claims 1 to 28.
